(19) United States
(12) Patent Application Publication
(10) Pub. No.: US 2016/0102556 A1
(43) Pub. Date: Apr. 14, 2016

(54) SHAFT ARRANGEMENT

(71) Applicant: SIEMENS AKTIENGESELLSCHAFT, München (DE)

(72) Inventor: Philip Twell, Welton, Lincoln (GB)

(73) Assignee: Siemens Aktiengesellschaft, Munich (DE)

(21) Appl. No.: 14/893,542

(22) PCT Filed: May 12, 2014
(86) PCT No.: PCT/EP2014/059649

§ 371 Date: Nov. 24, 2015

(30) Foreign Application Priority Data
Jun. 4, 2013 (GB) 1309952.8

(51) Int. Cl. F01D 5/06

(52) U.S. Cl. CPC F01D 5/066; F05D 2220/32; F05D 2230/60

(57) ABSTRACT

A rotor assembly and a method of assembling the rotor assembly typically for a turbine engine. The rotor assembly has a rotational axis, at least one rotor, a shaft having an axially extending bore, a tension stud extending axially through the rotor and into the bore for applying an axial load across the rotor and/or shaft. The rotor assembly further has a sleeve located at least partly within the bore and connected to the shaft by a first attachment and to the tension stud by a second attachment, the first attachment is located between the rotor and the second attachment.

### CROSS REFERENCE TO RELATED APPLICATIONS

This application is the US National Stage of International Application No. PCT/EP2014/059649 filed May 12, 2014, and claims the benefit thereof. The International Application claims the benefit of Great Britain Application No. GB 1309952.8 filed Jun. 4, 2013. All of the applications are incorporated by reference herein in their entirety.

### FIELD OF INVENTION

This invention relates to shaft arrangements particularly but not exclusively for turbine engines and turbo-machines having a compressor, a turbine or a power turbine mounted on an axial shaft.

### BACKGROUND OF INVENTION

In a turbine engine, compressors and turbines typically have axially arranged sets of rotors, each comprising an array of blades mounted to rotor discs. The respective sets of rotors are retained by a tension stud that extends through all or part of the set of rotors and is retained at one end by a shaft for example. A nut is used to apply a preload to the tension stud and thereby across the set of rotors to ensure secure operation of the compressor or turbine. The length and therefore the extension of the tension stud is critical to the life of the tension stud and the securing threads as well as being critical to the application of the correct preload. The correct tensile load is also necessary to achieve optimal transmission of torque and desired performance of the turbine engine. If an incorrect tensile load is applied the balance state of the rotor can change during operation giving rise to undesirable vibrations.

The fatigue life of the threads is a limiting factor to the pre-load that can be applied to the tension studs. To overcome this problem, it is known to use several smaller bolts instead of one central bolt; however, this arrangement requires significant space, is complex and incurs a high parts count. Another solution is to use a bolt extending through the shaft which is then bolted via nuts at both axial ends of the tension stud. Although this arrangement avoids the need for a thread internally in a bore of the shaft, it increases the axial length of the arrangement and adds complexity to the design.

Yet another solution involves a shorter tension stud length, which engages the shaft via an internal thread deep in an axial bore in the shaft. However, this design is problematic because the internal thread in the bore of the shaft is difficult to manufacture and inspect due to its location in the shaft. A shorter bore would then mean that the tension stud is also shorter and has less tensile extension and subsequently the design tensile load is difficult to apply and its performance during engine operation is compromised. Another problem is that in achieving a necessary tensile extension the applied load limits the life of the parts and particularly the connection threads.

U.S. Pat. No. 5,961,247A discloses a torque transfer mechanism for the detachable attachment of a bladed wheel to a shaft of a turbomachine. The bladed wheel has a sleeve-like extension that faces the shaft. A fastening unit is arranged in the sleevelike extension, the latter being circumscribed by a thicker wall bushing of a cylindrical recess of the shaft. A locking screw forces against clamping elements having sloping sides and which impart a radially outward force to secure the bladed wheel to the shaft via friction such that torque can be transmitted.

### SUMMARY OF INVENTION

One objective of the present invention is to eliminate the need for tapping, inspecting and maintaining a thread deep in a bore in a shaft. Another objective is to apply a predetermined tensile load.

One advantage of the present invention is a shorter tension stud arrangement. Another advantage is a connection to the shaft that is easier to form, inspect and maintain. Another advantage of the present invention is to maintain a desirable stud length to ensure accurate tensile load is applied and maintained across an associated rotor assembly. Another advantage is to prevent overstressing of a rotor assembly and/or the tension stud and of the shaft. Another advantage is to the improve low cycle fatigue of components of the shaft arrangement and rotor assembly.

For these and other objectives and advantages there is provided a rotor assembly for a turbine engine, the rotor assembly having a rotational axis, at least one rotor, a shaft having an axially extending bore, a tension stud extending axially through the rotor and into the bore to apply a compressive axial load across the rotor and/or shaft, the rotor assembly further having a sleeve is located at least partly within the bore and connected to the shaft by a first attachment and to the tension stud by a second attachment such that the sleeve incurs a compressive axial load, the first attachment is located between the rotor and the second attachment.

The bore may have a bore diameter and an entry plane, and at least a part of the first attachment is located within a distance twice the bore diameter from the entry plane.

At least a part of the first attachment may be located at the entry plane.

The sleeve may have an end and at least a part of the second attachment may be located within a distance three times the sleeve diameter from the end.

The sleeve may have an end and at least a part of the second attachment may be located within a distance equal to the sleeve diameter from the end.

The first attachment may be arranged to prevent relative axial movement between the sleeve and the shaft and second attachment may be arranged to prevent relative axial movement between the sleeve and the tension stud. Either or both the first and second attachments may be screw treads. Alternatively the first and second attachments may be bayonet type engagements. It is an important aspect that the sleeve is securely attached to the shaft to prevent the sleeve being forced out of the bore of the shaft. It is an important aspect that the sleeve is securely attached to the tension bolt. In this way via the tension bolt a compressive force can be exerted on the sleeve between the first and second attachments. Thus the first and second attachments must be capable of applying a compressive load therebetween. In turn the tension bolt incurs a tensile load and thereby a compressive force can be applied across the rotor assembly.

The sleeve has a cross-sectional area and the tension stud has a cross-sectional area and the sleeve and tension stud are made of materials having the same elastic modulus and their cross-sectional areas may be approximately the same.

The sleeve has a cross-sectional area and the tension stud has a cross-sectional area and the sleeve and tension stud may be made of materials having different elastic moduli from one another and their cross-sectional areas are different.

The rotor may comprises at least one rotor disc any can comprise a plurality of axially stacked rotors. Each rotor disc may have mounted thereon an annular array of radially extending blades. Alternatively, axially adjacent rotor discs may capture an annular array of radially extending blades therebetween.

The rotor may abut the shaft.

In another aspect of the present invention there is provided a method of assembling the rotor assembly described above. The method comprises the steps of inserting and connecting the sleeve to the bore of the shaft and inserting and connecting the tension stud to the sleeve.

The step of inserting and connecting the sleeve to the bore of the shaft may be completed prior to the step of inserting and connecting the tension stud to the sleeve.

Alternatively, the step of inserting and connecting the tension stud to the sleeve is completed prior to the step of inserting and connecting the sleeve to the bore of the shaft.

The rotor assembly may include a nut which is applied to a free end of the tension stud and engages the rotor at a first end; the method comprises the step of tightening the nut on the tension stud and against the first end to apply a tensile load across the rotor and shaft.

The tension stud may have a head which is integral or otherwise fixed and which engages the turbine at a first end, the method comprises the step of rotating the head and thereby rotating the tension stud relative to the sleeve to apply a tensile load across the rotor and shaft.

### BRIEF DESCRIPTION OF THE DRAWINGS

The above mentioned attributes and other features and advantages of this invention and the manner of attaining them will become more apparent and the invention itself will be better understood by reference to the following description of embodiments of the invention taken in conjunction with the accompanying drawings, wherein

FIG. 1 shows part of a turbine engine in a sectional view and in which the present invention is incorporated,

FIG. 2. shows an enlarged view of part section of a low-pressure turbine of the turbine engine and which shows the present invention in greater detail,

FIG. 3. is a section A-A shown in FIG. 2, and

FIG. 4 shows an enlarged view of part section of a low-pressure turbine of the turbine engine and which shows the present invention in further detail.

### DETAILED DESCRIPTION OF INVENTION

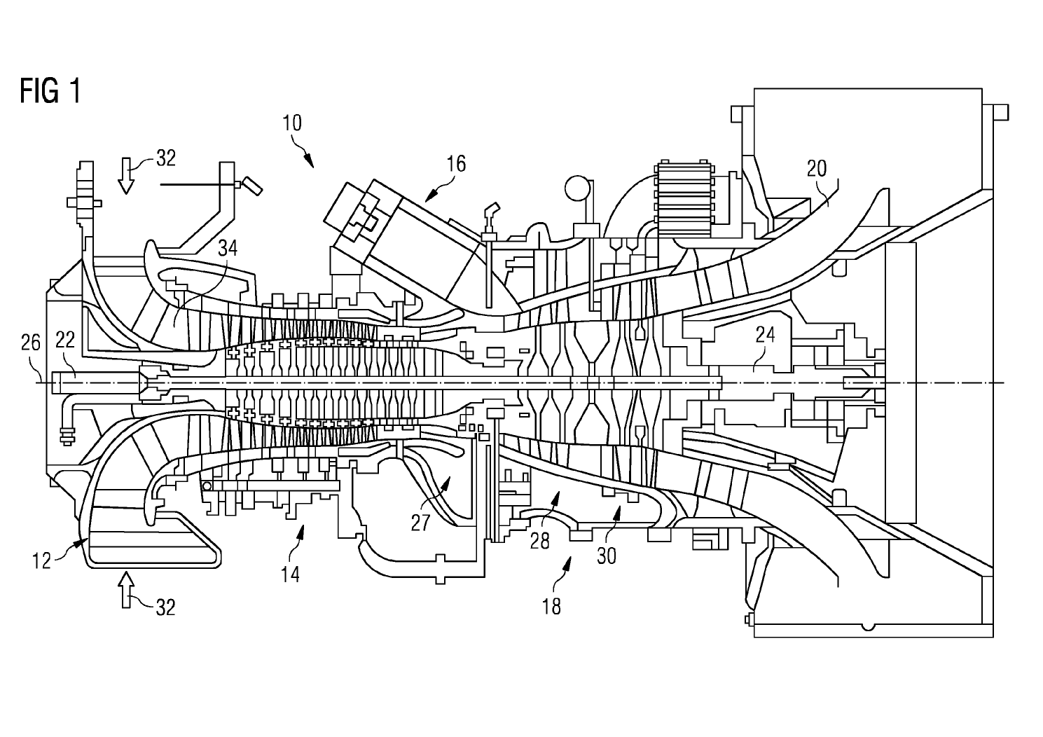

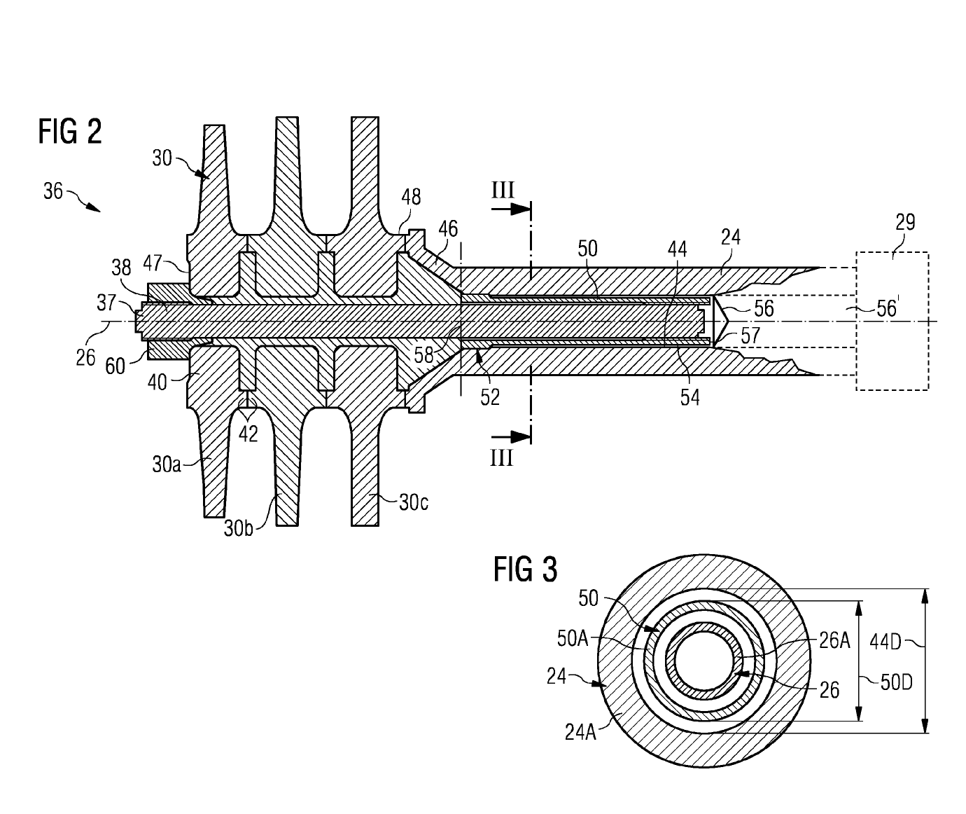

FIG. 1 is a schematic illustration of a general arrangement of a turbine engine 10 having an inlet 12, a compressor 14, a combustor system 16, a turbine system 18, an exhaust duct 20 and a twin-shaft arrangement 22, 24. The turbine engine 10 is generally arranged about an axis 26 which for rotating components is their rotational axis. The arrangements 22, 24 may have the same or opposite directions of rotation. The combustion system 16 comprises an annular array of combustor units 24, only one of which is shown. The turbine system 18 includes a high-pressure turbine 28 drivingly connected to the compressor 14 by a first shaft 22 of the twin-shaft arrangement. The turbine system 18 also includes a low-pressure turbine 30 drivingly connected to a load (29 shown in FIG. 2) via a second shaft 24 of the twin-shaft arrangement.

The terms radial, circumferential and axial are with respect to the axis 26. The terms upstream and downstream are with respect to the general direction of gas flow through the engine and as seen in FIG. 1 is generally from left to right.

The compressor 14 comprises an axial series of stator vanes and rotor blades mounted in a conventional manner. The stator or compressor vanes may be fixed or have variable geometry to improve the airflow onto the downstream rotor or compressor blades. Each turbine 28, 30 comprises an axial series of stator vanes and rotor blades mounted via discs 30a-c arranged and operating in a conventional manner.

In operation air 32 is drawn into the engine 10 through the inlet 12 and into the compressor 14 where the successive stages of vanes and blades compress the air before delivering the compressed air into the combustion system 16. In the combustor of the combustion system 16 the mixture of compressed air and fuel is ignited. The resultant hot working gas flow is directed into and drives the high-pressure turbine 28 which in turn drives the compressor 14 via the first shaft 22. After passing through the high-pressure turbine 28, the hot working gas flow is directed into the low-pressure turbine 30 which drives the load 29 via the second shaft 24.

The low-pressure turbine 30 can also be referred to as a power turbine and the second shaft 24 can also be referred to as a power shaft. The load 29 is typically an electrical machine for generating electricity or a mechanical machine such as a pump or a process compressor. Other known loads may be driven via the low-pressure turbine. The fuel may be in gaseous or liquid form.

The turbine engine 10 shown and described with reference to FIG. 1 is just one example of a number of turbine engines in which this invention can be incorporated. Such engines include single, double and triple shaft engines applied in marine, industrial and aerospace sectors. This invention may also be applied to steam turbines. Indeed the configuration of the present shaft arrangement can have utility for shafts found in other situation such as ship propeller shafts and land transport shafts.

FIG. 2 shows an enlarged view of part of a rotor assembly 36 of the turbine engine 10 and is in accordance with an exemplary embodiment of the present invention. In this example, the rotor assembly 36 includes the low-pressure turbine 30 and the second shaft 24 as introduced with reference to FIG. 1. The rotor assembly 36 includes a tension stud 38 arranged to apply an axial load across the turbine 30 and the second shaft 24 to secure the components of the rotor assembly 36 together.

The low pressure turbine 30 is shown here having three rotor discs 30a, 30b, 30c; however, the turbine can have one, two or more rotor discs or stages. The rotor discs 30a, 30b, 30c abut one another in an axial series or a rotor set via flanges 42 extending axially from their hub regions 40.

The shaft 24 has a cone portion 46 which abuts or engages with a disc flange 42 at a downstream or second end 48 of the turbine 30. The shaft 24 has an axially extending bore 44. The tension stud 38 extends axially through the turbine rotor set (30a-c) and into the bore 44. In this example the bore 44 extends a minimum distance within the shaft 24 and terminates at an end 56; however, the bore 44 can extend to any length within the shaft 24 and can extend completely through the shaft 24 as shown by the dashed lines to the end 56′.

The rotor assembly 36 further includes a sleeve 50 which is located at least partly within the axial bore 44 and in a radial sense between the tension stud 38 and the bore 44 of the shaft. Thus the tension stud 38 is partly surrounded by at least part of the sleeve 50 and which itself is radially outwardly surrounded by the shaft 24.

The sleeve 50 is connected to the shaft 24 by a first attachment 52 and to the tension stud 38 by a second attachment 54. In this embodiment the first attachment 52 is located between at least one of the rotors 30a-b and the second attachment 54. The relative locations of the attachments can be defined as the first attachment 52 is located between the downstream or second end 48 of the rotor 30 and the end 56 of the bore 44.

A nut 60 is applied to a free end 37 or forward end of the tension stud 38 and engages the turbine 30 at an upstream or first end 47. The nut 60 and tension stud 38 have cooperating threads and when the nut 60 is tightened against the first end 47 of the turbine 30 a tensile load is produced in the tension stud 38. In this way the shaft 24 and turbine 30 are securely fastened together for safe operation of the engine.

Alternatively to the nut 60, as shown in FIG. 2, the tension stud 38 can be provided with an integral head 60 which may be cast or welded to the tension stud for example. Rotation or tightening of the integral head 60 rotates the tension stud 38 which rotates relative to the sleeve at the second attachment 54 to thereby apply the required tensile load.

An anti-wear or anti-friction coating, washer or collar may be provided between the head 60 and the turbine to prevent damage during assembly, disassembly and engine operation.

The bore 44 has an entry plane 58 and the first attachment 52 is located near to the entry plane 58 while the second attachment 54 is located near the end 56 of the bore 44. In this exemplary embodiment, the first attachment 52 is immediately next to or at the entry plane 58 although in other embodiments the first attachment 52 can be recessed into the bore 44 a distance. In some cases, this distance may be up to twice the diameter 44D of the bore from the entry plane 58. Similarly, in this exemplary embodiment, the second attachment 54 is located near to an end 57 of the sleeve 50 and at least a part of the attachment 54 is within a distance, from the end 57, of one diameter 50D of the sleeve 50, but may be up to three diameters 50D of the sleeve 50. Where possible the second attachment 54 is located near to the end 56 of the bore 44 and in particular at least a part of the attachment 54 is within a distance, from the end 56, of up to three diameters of the bore 44. The relative locations of the first and second attachments 52, 54 can be defined as the first attachment 52 being located between the entry plane 58 and the second attachment 54.

In this embodiment, the first and second attachments 52, 54 are complimentary threaded formations on the shaft/sleeve and sleeve/tension stud respectively. The direction of the threads is opposite the direction of torque transfer between turbine 30 and shaft 24 during normal engine operation when driving the load. This is advantageous because in this embodiment the threads are transmitting torque and thus the assembly does not try to unscrew the threads. However, it is not necessary for the threads to be opposite the direction of torque transfer between turbine 30 and shaft 24 where torque transmission is via features such as locking pins, curvic or Hirth couplings as are known in the art.

In this example, the first and second attachments 52, 54 have differing pitches of helical angles for their respective threads. Thus if the threads try to unwind in one direction the tension increases to prevent disengagement of the shaft 24, tension stud 38 and sleeve 50. In this case an end stop can be installed to prevent relaxation of the assembly.

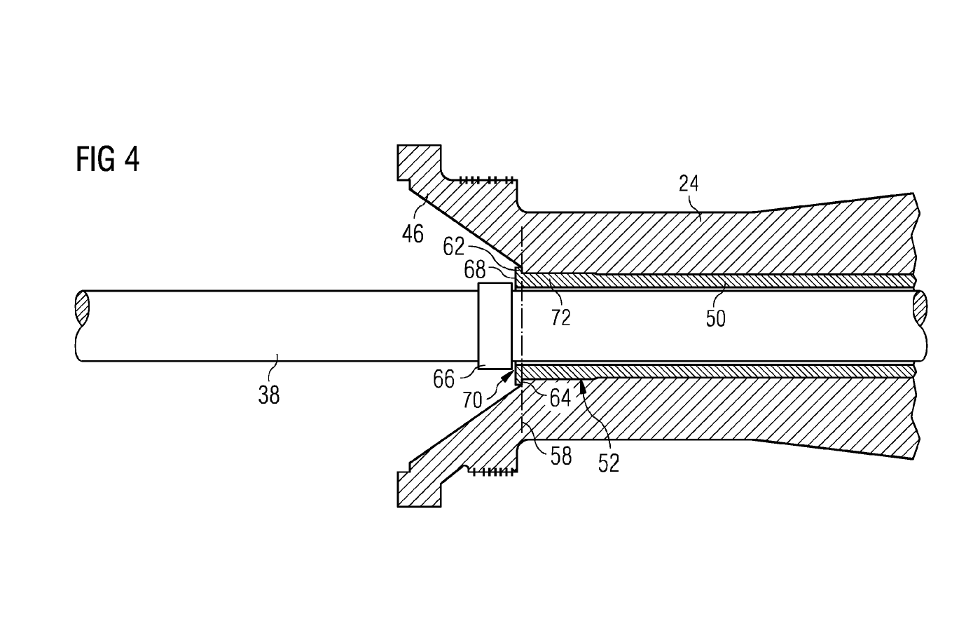

Referring to FIG. 4, the sleeve 50 includes a stop 62 which is this example is a flange surrounding or part-surrounding the circumference of the sleeve and is located at an axially forward end 72 of the sleeve 50. The stop 62 abuts a surface 64 of the shaft 24 which is generally aligned with or in the plane 58. The tension stud 38 could have a stop feature positioned anywhere along its length and that engages with the sleeve or a disc or even abut the end of the bore 44.

The stop 62 and surface 64 accurately locate a relative axial position of the sleeve 50 and shaft 24. This is advantageous to ensure the cooperating threads fully engage one another to maximise thread length overlap and to transfer torque and tensile loads between threaded components. Additionally, an anti-rotation feature such as a tabbed washer, a stake or a pin may be used to lock the sleeve 50 and shaft 24 together and to prevent unwind when removing the tension stud 38.

FIG. 4 further shows the tension stud 38 having a stop 66 to axially locate, in a desired position, the tension stud 38 within the sleeve 50 during assembly of the two components. The stop 66 is a circumferentially extending flange and which engages or abuts with a forward surface 68 of the sleeve 50. After the tension stud and sleeve assembly is inserted and assembled to the shaft 24, an axial load is applied to the tension stud 38 whereupon a gap 70, as shown, usually occurs between the stop 66 and forward surface 68. It should be appreciated that the stop feature could be positioned relative to any suitable feature of the assembly, for example, in end of the bore or a disc face and giving the same functionality.

Instead of cooperating threaded connections it is possible that one or both the first and second attachments are welded, brazed or otherwise engaged. In particular, the threaded connection 54 is not a prerequisite and it could be replaced by a brazed or weld join. Threaded connection 52 could be replaced by a bolted flange where space permits. Still further, the tension stud could have a head or flange at its rearward or downstream end and that locates against a downstream or rearward end or surface 57 of the sleeve 50.

One advantage of the rotor assembly 36 is that the effective axial length of the tension stud 38 is increased by virtue of the axial length of the sleeve 50 and the axial separation of the locations of the first and second attachments 52, 54. Thus this configuration is advantageous because the tension stud can be axially shorter than previous designs. Having the present axially shorter tension stud 38 allows the bore 44 to be axially shorter by approximately the distance between the first and second attachments 52, 54. The tension stud and sleeve combination enables improved performance in terms of applying a desired axial load across the turbine and/or across the turbine and shaft interface. Thus the rotor assembly or shaft arrangement is more compact in axial length than previous designs. In addition, the fatigue life of the components is improved because the correct load and torque response of the components is achieved.

Another advantage of the rotor assembly described herein is that the first attachment 52, connecting the shaft 24 and sleeve 50, is at or near to the entry plane 58 of the bore 44. Such a location of the first attachment 52 allows easier access to manufacture the first attachment, particularly if a thread is formed in the bore.

Assembly, inspection of and modification to the thread is correspondingly relatively easy. In previous designs the attachment thread has been located at the end 56 of the bore 44 where the tension stud 38 engages the shaft 24. Thus access for manufacture and inspection for wear and fatigue are compromised for the previous designs.

FIG. 3 is a section A-A shown in FIG. 2 and is an axial cross-section through the shaft 24, sleeve 50 and tension stud 38. The shaft 24, sleeve 50 and tension stud 38 have cross-sectional areas 24A, 50A and 38A respectively. The advantage of improved performance in terms of applying a desired axial load across the turbine and/or across the turbine and shaft interface is realised by the tension stud 38 and sleeve 50 having similar elastic performance across the range of operating conditions. This is achieved by the tension stud 38 and sleeve 50 having complimentary cross-sectional areas. Having complimentary cross-sectional areas 26A and 50A allows the tension stud 38 to extend or stretch and the sleeve 50 to compress or shorten relatively equally when a load is applied to the tension stud. In this example the tension stud 38 and sleeve 50 are manufactured from the same material and their cross-sectional areas are approximately equal and advantageously equal. Thus the tension stud extends and the sleeve compresses relatively equally and depending on their respective effective lengths. The effective length of the tension stud is between the nut or head 60 and the first attachment 52 and the effective length of the sleeve is between the first attachment 52 and second attachment 54.

The term ‘complimentary’ has been used to describe the relative cross-sectional areas of the tension stud 38 and sleeve 50. It is desirable that the elastic deformation of both components occurs relatively equally so that the full potential ‘effective extension’ of the tension stud 38 and sleeve assembly is realised. Where the tension stud 38 and sleeve 50 are made from different materials having different elastic moduli the cross-sectional areas of the tension stud and sleeve will need to be different to accommodate the difference in elastic moduli. In general, where one of the tension stub or sleeve has a lower elastic modulus then its cross-sectional area is correspondingly greater and vice versa.

The arrangement of attachment points 52, 54 and complimentary cross-sectional areas has the overall result of effectively lengthening the tension stud. Thus a shallower bore is possible compared to previous designs that do not have a sleeve and the present shaft arrangement 36 eliminates the need to tap a thread in the bottom of a relatively deep bore.

Although each application of the present invention will have varying dimensions, in one example, the sleeve 50 has a length of about 4.5 times the external diameter 50D of the tension stud 38. Generally, the sleeve 50 has a length greater than 3 times the tension stud diameter 50D at a lower and practical length to gain at least some of the advantages mentioned herein. Typically, the sleeve 50 would be within the range 4 to 5 times the tension stud diameter 50D.

It should be appreciated that the rotor assembly 36 can be applied to many configurations of turbine engines or shaft arrangements without departing from the teachings of the invention. For example, the load 29 can be positioned axially forward of the turbine 30 rather than axially rearward as shown in FIG. 2. In another example, the rotor assembly may include the high pressure turbine 28. In this example the shaft 22 may constitute two parts or tension studs, one either side of a bearing 27 (shown in FIG. 1).

The method of assembling the rotor assembly 36 described above comprises inserting and connecting the sleeve 50 to the bore of the shaft and inserting and connecting the tension stud 38 to the sleeve 50. Where threads are used for connecting the sleeve to the shaft the sleeve 50 is rotated along the thread in the entrance to the bore until the sleeve 50 is in its desired axial position. The tension stud 38 is also rotated or screwed to form the second connection 54 between the tension stud and sleeve 50. The rotor 30 is then assembled and brought into a coaxial position with the tensions stud and shaft 24. The rotor 30 is moved axially until the second end 48 of the rotor 30 and the cone 46 of the shaft 24 abut one another. The nut 60 is applied to the free end 37 of the tension stud 38 and is tightened or rotated to engage the rotor 30 at its first end 47. The nut 60 is further rotated or tightened on the tension stud 36 and against the first end 47 to apply a tensile load across the rotor 30 and shaft 24. The tensile load ensures the rotor stages or discs 30a-c are located correctly and rotate together about the axis 26. The tensile load also ensures appropriate engagement of the rotor and shaft for transference of driving torque to the load 29.

Instead of a nut 60, the tension stud 38 may have the integral head 60 and which engages the turbine 30 at the first end 47. The head 60 may be integral or fixed to the tension stud by other means. In this alternative arrangement, the assembly comprises the step of rotating the head 60 and thereby rotating the tension stud 36. The tension stud 36 rotates relative to the sleeve 50 and pulls the sleeve and tension stud toward one another thereby applying a tensile load across the rotor and shaft 24 as discussed above.

The method of assembling the rotor assembly can be done by inserting and connecting the tension stud to the sleeve prior to the step of inserting and connecting the sleeve to the bore of the shaft. This method of assembly is possible where the tension stud has the integral head 60 or flange at its rearward or downstream end and which, when assembled, locates against a downstream or rearward end or surface 57 of the sleeve 50.

While the invention has been illustrated and described in detail for a preferred embodiment the invention is not limited to these disclosed examples and other variations can be deducted by those skilled in the art in practicing the claimed invention.

1. A rotor assembly for a turbine engine, the rotor assembly comprising:
a rotational axis,
at least one rotor,
a shaft having an axially extending bore,
a tension stud extending axially through the rotor and into the bore adapted to apply a compressive axial load across the rotor and shaft,
a sleeve located at least partly within the bore and connected to the shaft by a first attachment and to the tension stud by a second attachment such that the sleeve incurs a compressive axial load,
the first attachment located between the rotor and the second attachment.

2. A rotor assembly as claimed in claim 1,
wherein the bore has a bore diameter and an entry plane, and at least a part of the first attachment is located within a distance twice the bore diameter from the entry plane.

3. A rotor assembly as claimed in claim 2,
wherein at least a part of the first attachment is located at the entry plane.

4. A rotor assembly as claimed in claim 1,
wherein the sleeve has an end, at least a part of the second attachment is located within a distance three times the sleeve diameter from the end.

5. A rotor assembly as claimed in claim 1,
wherein the sleeve has an end, at least a part of the second attachment is located within a distance equal to the sleeve diameter from the end.

6. A rotor assembly as claimed in claim 1,
wherein the first attachment is arranged to prevent relative axial movement between the sleeve and the shaft and second attachment is arranged to prevent relative axial movement between the sleeve and the tension stud.

7. A rotor assembly as claimed in claim 1,
wherein the sleeve has a cross-sectional area and the tension stud has a cross-sectional area and
wherein the sleeve and tension stud are made of materials having the same elastic modulus and their cross-sectional areas are approximately the same.

8. A rotor assembly as claimed in claim 1,
wherein the sleeve has a cross-sectional area and the tension stud has a cross-sectional area and
wherein the sleeve and tension stud are made of materials having the different elastic moduli and their cross-sectional areas are different.

9. A rotor assembly as claimed in claim 1,
wherein the rotor comprises at least one rotor disc.

10. A rotor assembly as claimed in claim 1,
wherein the rotor abuts the shaft.

11. A method of assembling the rotor assembly of claim 1, the method comprising:
inserting and connecting the sleeve to the bore of the shaft, and
inserting and connecting the tension stud to the sleeve.

12. A method of assembling the rotor assembly as claimed in claim 11
wherein the step of inserting and connecting the sleeve to the bore of the shaft is completed prior to the step of inserting and connecting the tension stud to the sleeve.

13. A method of assembling the rotor assembly as claimed in claim 11
wherein the step of inserting and connecting the tension stud to the sleeve is completed prior to the step of inserting and connecting the sleeve to the bore of the shaft.

14. A method of assembling the rotor assembly of claim 11,
wherein the rotor assembly includes a nut which is applied to a free end of the tension stud and engages the rotor at a first end, the method further comprises:
tightening the nut on the tension stud and against the first end to apply a tensile load across the rotor and shaft.

15. A method of assembling the rotor assembly of claim 11,
wherein the tension stud has a head and which engages the rotor at a first end, the method further comprises:
rotating the head and thereby rotating the tension stud relative to the sleeve to apply a tensile load across the rotor and shaft.
